(19) United States
(12) Patent Application Publication
(10) Pub. No.: US 2013/0346589 A1
(43) Pub. Date: Dec. 26, 2013

(54) NOTIFICATION-BASED MONITORING OF WEB RESOURCES

(71) Applicants: Ihor Leshko, Redmond, WA (US); Yossi Firstenberg, Redmond, WA (US); Nalin Kumar, Redmond, WA (US)

(72) Inventors: Ihor Leshko, Redmond, WA (US); Yossi Firstenberg, Redmond, WA (US); Nalin Kumar, Redmond, WA (US)

(73) Assignee: Microsoft Corporation, Redmond, WA (US)

(21) Appl. No.: 13/528,873

(22) Filed: Jun. 21, 2012

(51) Int. Cl. G06F 15/173

(52) U.S. Cl. 709/224

(57) ABSTRACT

A service allows client systems to register for push notifications from the service about changes to resources. The service monitors a resource for updates and then notifies the client system when the resource has an update. The client system registers a resource for monitoring and subscribes to receiving push notifications for resources that are monitored. The client system can provide a notification channel to the service over which the service can send push notifications. The service aggregates requests to monitor resources over multiple client systems. When the service detects a change to a monitored resource, the service broadcasts a push notification to the various client systems subscribed to receive notifications for that resource over their respective notification channels.

### BACKGROUND

A resource on a computer network, such as a web site on the internet, is generally treated as a static resource by a client system that accesses the resource. For example, when a client system, such as a web browser on a personal computer, accesses a web site, the client system sends a request message to a specified server with a resource locator (such as a URL) for the resource. The server responds to the web browser with the resource corresponding to the designated resource locator.

If a user wants to know if the resource has been updated, then the user can instruct the client system to send another request message to the server, and obtain another response. A web browser typically has this functionality available to the user through a “refresh” button in its graphical user interface.

Some resources allow a user to register to be informed of updates to a resource. For example, a user may receive an electronic mail message that a resource has been updated. After receiving such a message, the user then accesses the updated resource using a client system such as a web browser. In some cases, a message about the update is sent directly to the client system that accesses the server where the resource resides. Such a message is commonly referred to as a push notification. Push notifications typically are used with by resource, such as a web-based game or a news service, which has a dedicated user application on a user device, such as a user interface for the web-based game or a news reader for the news service.

Otherwise, more generic client systems, such as web browsers on personal computers, typically are operational only during explicit user interaction. This kind of client system relies on user interaction, or a notification to solicit user interaction, in order to resume operation. Thus, such client systems generally do not update information about resources independently of user interaction. In some instances, such client systems can be suspended by an operating system. When suspended any activity other than user interaction can be blocked by the operating system.

### SUMMARY

This Summary introduces concepts in a simplified form that are further described below in the Detailed Description. This Summary is neither intended to identify essential features of the claimed subject matter, nor to limit the scope of the claimed subject matter.

A service allows client systems to register for push notifications from the service about changes to resources. The service monitors a resource for updates and then notifies the client system when the resource has an update. The client system registers a resource for monitoring and subscribes to receiving push notifications for resources that are monitored. The client system can provide a notification channel to the service over which the service can send push notifications. The service aggregates requests to monitor resources over multiple client systems. When the service detects a change to a monitored resource, the service broadcasts a push notification to the various client systems subscribed to receive notifications for that resource over their respective notification channels.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an example operating environment for a service that provides notifications to applications about resources.

FIG. 2 is a more detailed block diagram illustrating components in an example implementation of the service in FIG. 1.

FIG. 3 illustrates an example implementation of a database used by the service of FIG. 2.

FIG. 4 is a flow chart describing the operation of an example implementation of a client system in FIG. 1.

FIG. 5 is a flow chart describing the operation of an example implementation of a service, interacting with an application, in FIG. 1.

FIG. 6 is a flow chart describing the operation of an example implementation of a service, interacting with a resource, in FIG. 1.

FIG. 7 is a flow chart describing the operation of an example implementation of a resource in FIG. 1.

FIG. 8 is a block diagram of an example computing functionality with which such a system can be implemented.

### DETAILED DESCRIPTION

The following section provides an example operating environment in which a monitoring and notification service can be implemented.

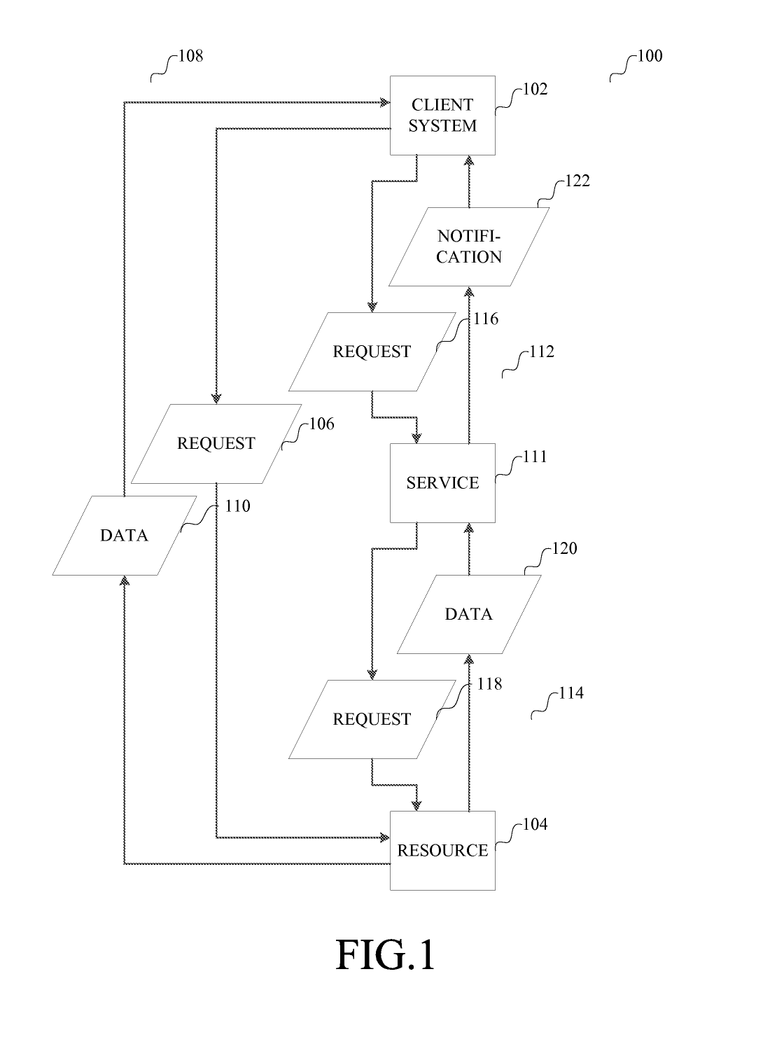

Referring to FIG. 1, a computer system 100 includes a client system 102 that accesses a resource 104 by transmitting a request 106 over a computer network 108. The resource 104 responds to the request by transmitting data 110 over the computer network.

The client system can be, for example, a computing device running an application. Example computing devices include, but are not limited to, a general purpose computer, a desktop computer, a personal computer, a handheld computer, a tablet computer, a notebook or laptop computer, a game console, a mobile device such as a smart phone, or other computing device. The application can be, for example, a browser application or other application that can access a resource over a computer network.

The computer network 108, 112, 114 can be one or more computer networks, such as a local area network, a wide area network, a private network or a public network such as the internet, and can be implemented with both wired and wireless communication technologies.

The resource can be any computing device running an application that provides data and that is accessible by the client system over such a computer network. The resource can be identified, for example, by a uniform resource locator according to HTTP or similar communication protocol over the internet. An example resource is a web site accessible on a web server over the internet.

The client system also accesses a service 111 over a computer network 112. In particular, the client system transmits to the service 111 a request 116 that includes an identifier of a resource 104.

The service can be implemented using one or more computing devices and applications running on such devices. Example computing devices include a server computer in addition to other types of computing devices described herein. The application can be implemented in accordance with the description herein, similar to a web server.

The service accesses the resource 104 over a computer network 114. In one implementation, the service periodically polls the resource, for example by transmitting a request 118 similar to request 106 over the computer network 114 to the resource 104. The resource 104 responds to the request by transmitting data 120 over the computer network 114 to the service 111. In another implementation, the resource notifies the service if there is a change. The service can store data 120 received at different times to permit for comparison to determine if a change has occurred. If there is a change in the resource, the service transmits a push notification 122 over a notification channel on the computer network 112 to the client system 102.

A notification channel between a service and an application is a communication channel established between the service and a computing device on which the application resides. A push notification is a message sent to an application on the computing device over this communication channel. The computing device processes push notifications received by the device and directs an appropriate message to the corresponding application.

It should be understood that an implementation typically involves a plurality of client systems and a plurality of resources. In particular, a client system can include any computing device with a browser application connected to the internet or similarly constructed private computer network. Similarly, a resource can include any server providing data on the internet, or similarly constructed private computer network, to such client systems.

One example application environment includes numerous client systems, such as consumers with phones that include web browsers or other applications that access various web services over the internet, whether through wireless internet or cellular telephone communication technologies. In such an environment, such a service allows phone users to receive updates to resources via push notifications.

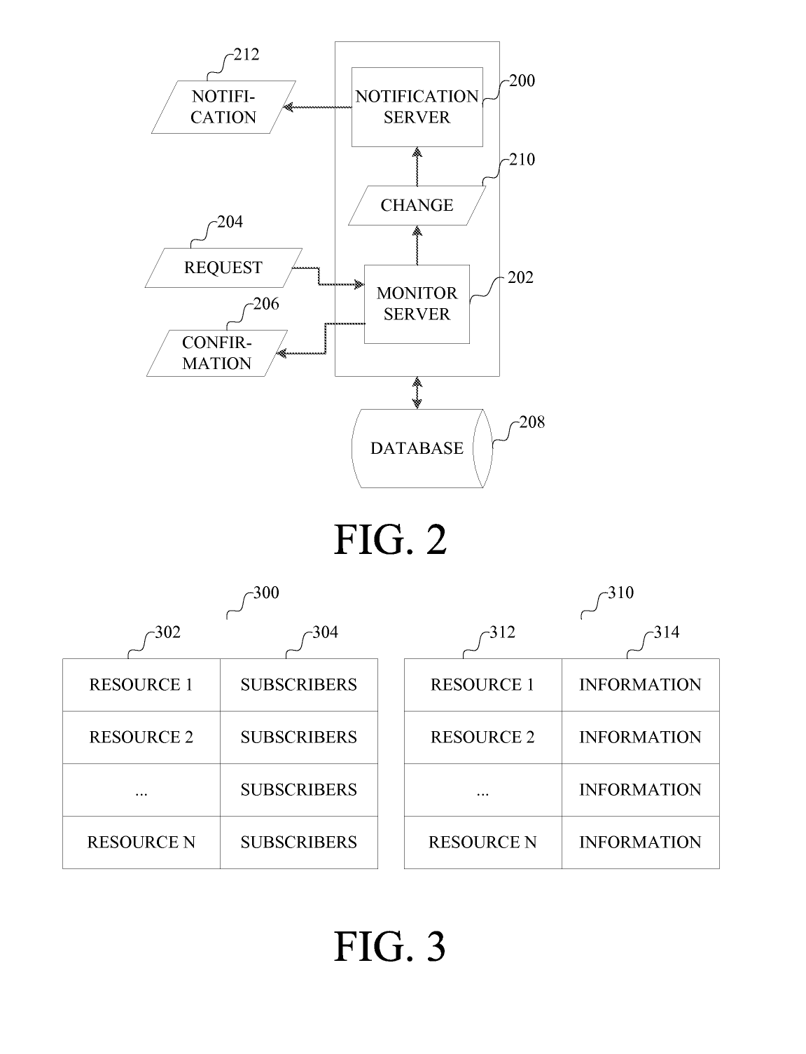

Given this context, an example implementation of such a system will be described in more detail in connection with FIGS. 2-4.

In the implementation shown in FIG. 2, the service includes a notification server 200 and a monitor server 202. The monitor server receives requests 204 from a client system identifying a resource to be monitored. The monitor server can respond with a confirmation 206 of the request. The monitor server in turn monitors resources by either periodically polling or receiving notifications from the resources. The monitor server maintains a database 208 of the resources being monitored, and the client systems for which the resources are being monitored. The monitor server can store data received at different times from the resource to permit for comparison to determine if a change has occurred.

After the monitor server 202 receives an indication that a monitored resource has changed, a message 210 is passed to the notification server. The notification server then sends a push notification 212 to the corresponding client system(s) over the respective push notification channels indicating that a change in the resource has occurred.

Turning now to FIG. 3, an example implementation of a database 208 in FIG. 2 will now be described. In general the database relates a client system with a resource to be monitored by the service for that client system.

In one implementation, the database 208 includes a subscription list 300 that includes, for each resource 302, a list 304 of identifiers of push notification channels for each client system that is subscribed to receive push notifications about changes in that resource. The resource 302 can be identified by its URL, for example. The subscription list is primarily accessed by the notification server, so that, given a resource that has changed, the appropriate client systems can be notified. The service aggregates the incoming monitoring requests from different client systems on the basis of the subscribed resource in the subscription list. The service then can use the subscription list to broadcast any changes from the monitored resource to the subscribers (client systems).

The database also can include a watch list 310 that includes, for each resource 312, information 314 about the resource. Examples of such information include, but are not limited to, describing how the resource can be polled, a callback URI allowing the resource to contact the monitor server, and other information. The watch list is primarily accessed by the monitor server in issuing polling requests to the monitored resources.

Having now described an example implementation of a service, an example of the system operation will now be described.

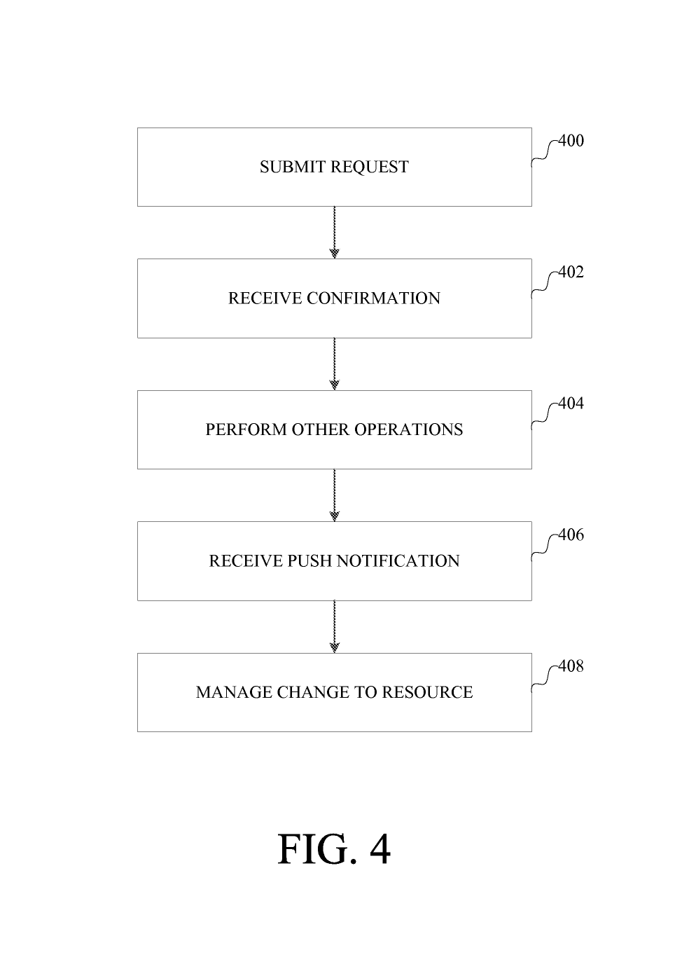

FIG. 4 is a flow chart describing the operation of an example implementation of a client system in FIG. 1 to cause a resource to be monitored.

The client system submits 400 a request to the service to monitor a resource. The request can include an identifier of the resource to be monitored, such as a URI, a push notification channel for the client system and other information, such as authorization information, monitoring and filtering parameters and the like. The client system can receive 402 a confirmation from the service indicating whether the service has accepted the request. One or more of such requests and confirmations can be sent and received. A client system thus can have many resources being monitored by the service on its behalf

After subscribing to monitor a resource, a client system can perform 404 other operations, or even be suspended. Such activity can continue with the client system until it receives 406 a push notification from the service indicating that a monitored resource has changed. At this time the client system can manage 408 the change. For example, the client system can present the user with an opportunity to access the changed resource. For example, the client system can present the user with an interface through which the user can instruct the client system to access the changed resource. As another example, the client system can present the user with an interface through which the changed resource is displayed. As another example, the client system can direct an application to perform some background processing.

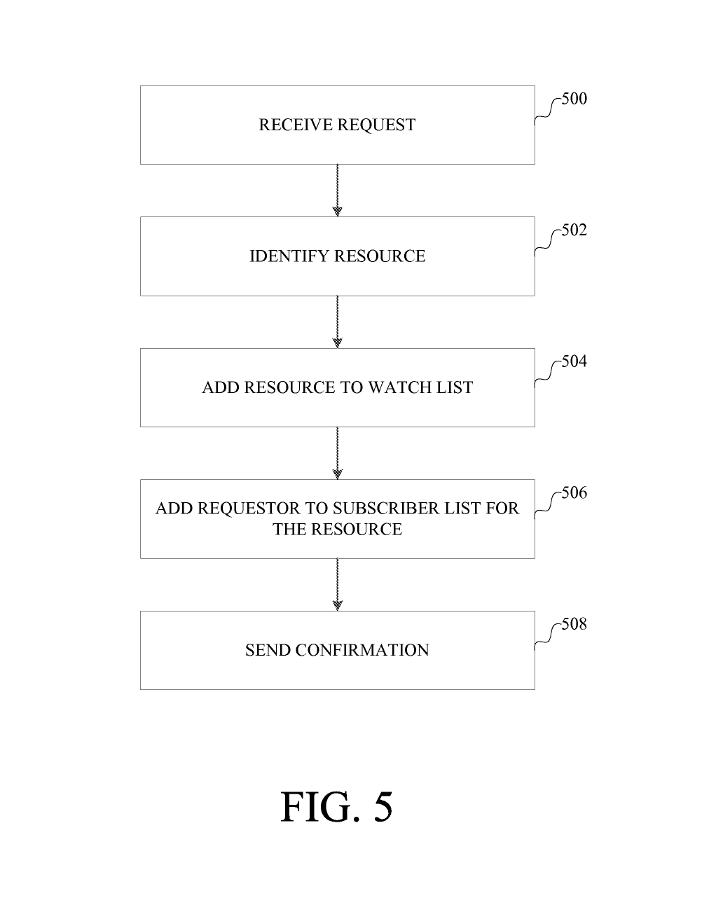

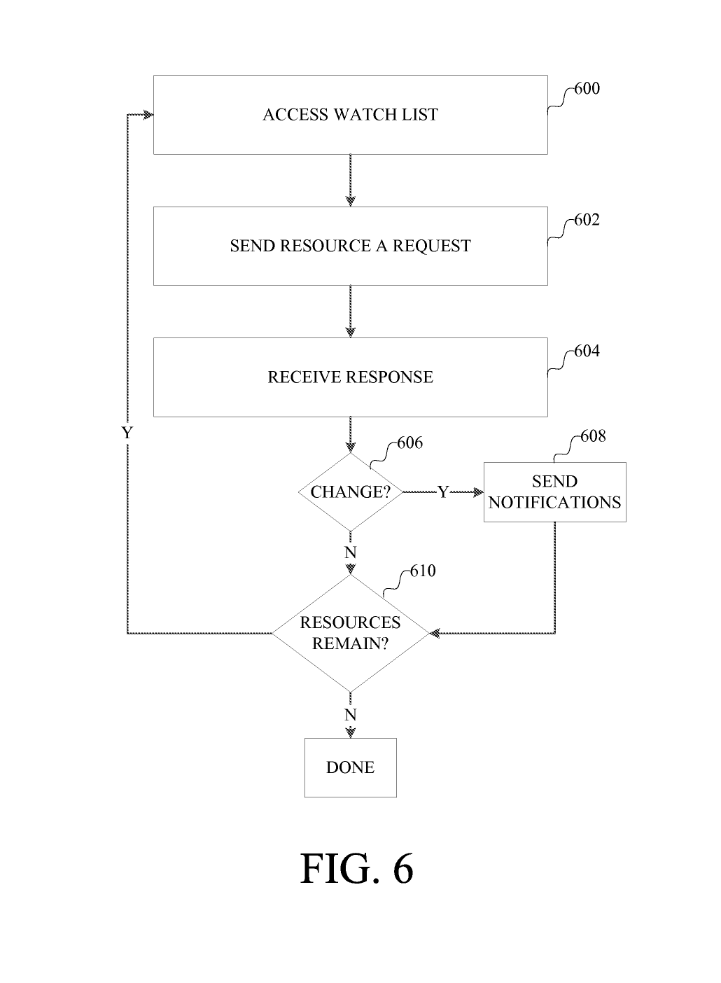

In this implementation, the service implements the processes shown in FIGS. 5 and 6. In FIG. 5, the service receives 500 a request from a client system. The resource in the request is identified 502, and added 504 to the watch list for the service. The identifier of the push notification channel for the client system, or other identifier for the requestor, is added 506 to the subscriber list for the resource. If such a list has not yet been created for the resource, the subscriber list for that resource also is created. After preparing itself in this way to monitor the resource, the service sends 508 a confirmation message to the client system. Multiple such requests can be received by the service, from multiple client systems.

FIG. 6 shows the monitoring and notification process in this implementation of the service. In this implementation, the service polls each resource at a set time interval. At this time interval, the service steps through its watch list and sends polling requests to the monitored resources. For example, the service accesses 600 the watch list to obtain an identifier for a resource. The service sends 602 the resource a request. The service then receives 604 any response from the resource. If the response indicates a change in the resource, as determined at 606, then the service sends 608 a push notification to all of the client systems subscribed to that resource over their respective notification channels according to the subscription list. This process continues for each remaining resource on the watch list, as indicated at 610.

In the example implementation described above, the resource can be unaware of the monitoring by the service. The resource simply receives a request from the service and responds, allowing the service to determine if there has been any change. It is also possible for the resource to be programmed to respond to a request from the service by initiating its own notification process to inform the service when the resource has changed. In this implementation, the request from the service includes a “callback” URL, which the resource identifies in the request. The callback URL is a URL for the service to receive notifications from the resource. For example, given a web resource accessed by a GET message over an HTTP connection, text such as “X-Notify-On-Change: http://[service-domain-name].[top-level-domain-of-service]/?resource=[resource-identifier]” can be included in the GET message posted to the resource. The resource can save this information and use it to send a POST message to the service when a change occurs. Such a message can include, for example, the identifier of the resource and the date and time of the last change to that resource.

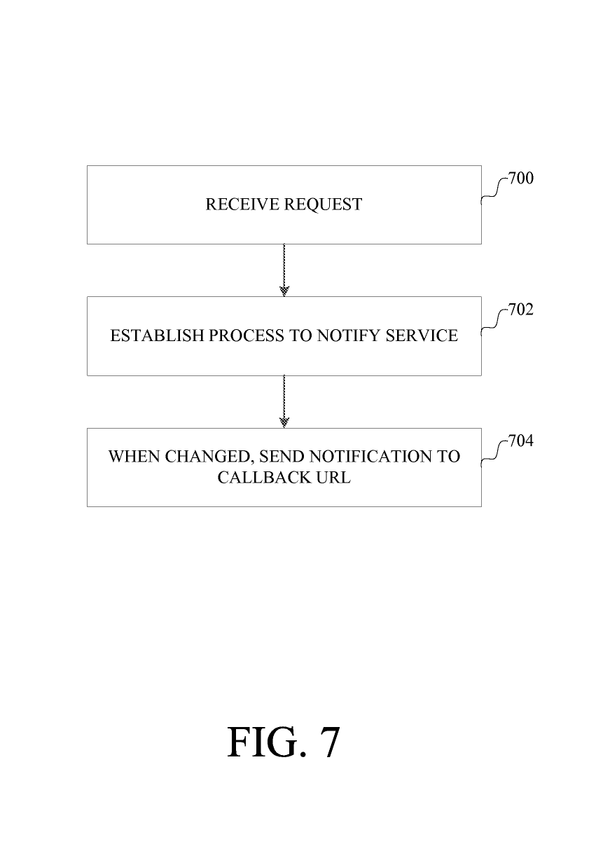

With reference to FIG. 7, an implementation of a resource that provides notifications to the service will now described. The resource receives 700 a request from a service that includes a destination to which the resource sends a message indicating when the resource has been changed. An example is a callback URL. The resource establishes and maintains 702 a process that detects whether the resource has changed. Upon a change occurring to the resource, the resource sends 704 a notification to the callback URL indicating that the resource has changed.

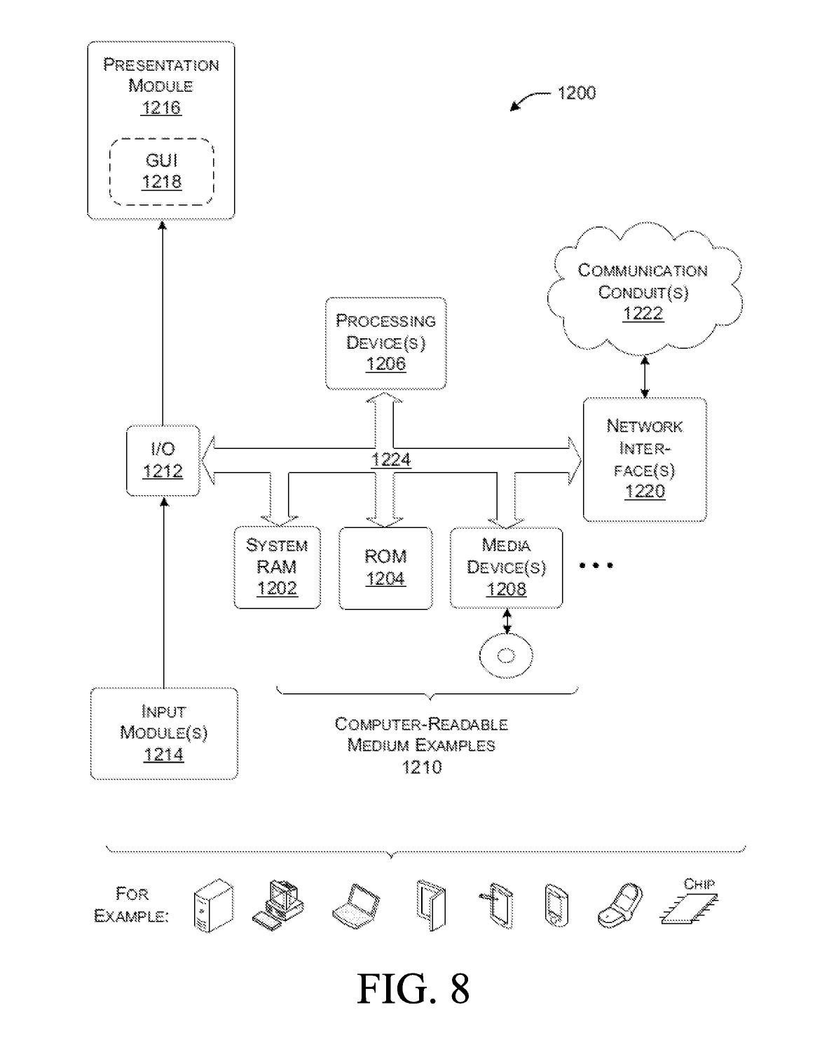

FIG. 8 sets forth illustrative computing functionality 1200 that can be used to implement any aspect of the functions described above. For example, the computing functionality 1200 can be used to implement any aspect of the client system, service, or resource of FIG. 1, or notification server or monitor server of FIG. 2. Such components in FIGS. 1 and 2 can be implemented on one or more computing functionalities, and in some cases a distributed system can have each module reside on its own computing functionality. In the deployment of an application program or library, an application framework, library and program using the library can utilize one or more computing functionalities as well. In all cases, the computing functionality 1200 represents one or more physical and tangible processing mechanisms.

The computing functionality 1200 can include volatile and non-volatile memory, or other machine-readable storage, such as RAM 1202 and ROM 1204, as well as one or more processing devices 1206 (e.g., one or more central processing units (CPUs), and/or one or more graphical processing units (GPUs), and/or other coprocessors, etc.). The computing functionality 1200 also optionally includes various machine-readable storage devices 1208, such as a hard disk module, an optical disk module, digital versatile disk (DVD), compact disc (CD) and so forth. The computing functionality 1200 can perform various operations, and manage data in memory, as identified above when the processing device(s) 1206 processes (e.g., executes or interprets) instructions that are maintained by memory (e.g., random access memory (RAM) 1202, whether static or dynamic, read-only memory (ROM) 1204, whether erasable or not, or elsewhere). More generally, computer program instructions or software, and other information, can be stored on any computer-readable storage 1210, including, but not limited to, static memory storage devices, magnetic storage devices, optical storage devices, and so on. The term computer-readable storage also encompasses plural storage devices. In all cases, the computer-readable storage 1210 represents some form of physical and tangible entity.

The components of this system may be implemented using software, including computer-executable instructions and/or computer-interpreted instructions, being processed by a computing machine. Such instructions, when processed by a computing machine, instruct the computing machine to perform particular tasks or to implement particular abstract data types or to configure itself to provide particular structures. Such computer program instructions or software, stored on computer-readable storage, constitutes a computer program product.

The computing functionality 1200 also includes an input/output module 1212 for receiving various inputs (via input modules 1214), and for providing various outputs (via output modules).

Input module 1214 may utilize various input device(s) such as a keyboard, mouse, pen, camera, touch input device, and so on. Other input devices that support natural user interfaces also can be used. A natural user interface is any interface technology that enables a user to interact with a device in a “natural” manner, free from artificial constraints imposed by other mechanical input devices. Examples of natural user interfaces include, but are not limited to, speech recognition, touch and stylus recognition, gesture recognition both on screen and adjacent to the screen, air gestures, head and eye tracking, voice and speech, vision, touch, gestures, and machine intelligence. Various input devices, such as sensors, are used to support such natural user interfaces.

Output modules may utilize various output device(s) such as a display, speakers, a printer, and so on. One particular output mechanism may include a presentation module 1216 and an associated graphical user interface (GUI) 1218.

The computing functionality 1200 can also include one or more network interfaces 1220 for exchanging data with other devices via one or more communication conduits 1222. One or more communication buses 1224 communicatively couple the above-described components together. The communication conduit(s) 1222 can be implemented in any manner, e.g., by a local area network, a wide area network (e.g., the Internet), etc., or any combination thereof. The communication conduit(s) 1222 can include any combination of hardwired links, wireless links, routers, gateway functionality, name servers, etc., governed by any protocol or combination of protocols.

The computing functionality can be implemented with numerous general purpose or special purpose computing hardware configurations. Examples of computing devices that may be suitable include, but are not limited to, personal computers, server computers, hand- held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

Alternatively, or in addition, various functions can be performed, at least in part, by one or more hardware logic components. For example, without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

The terms “article of manufacture”, “process”, “machine” and “composition of matter” in the preambles of the appended claims are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. A computer-implemented process for monitoring of one or more resources, the one or more resources being connected in a computer system including one or more client systems and a service, the service including a server computer and a service application running on the server computer, and a resource including a computing device providing information in response to requests from the one or more client systems and the service over one or more computer networks, and a client system including a computing device and an application running on the computing device that requests information from the one or more resources over the one or more computer networks, the client system further being connected to the service over one or more computer networks and having a notification channel, the process comprising:
receiving at the service one or more requests into memory from one or more client systems over a computer network, a request including an indication of one of the resources to be monitored;
the service monitoring, over the one or more computer networks, the one or more resources from the one or more requests for changes;
after one of the resources changes, the service sending a push notification to each client system, over the notification channel for the client system, which requested the resource to be monitored about the change.

2. The computer-implemented process of claim 1, wherein the service includes a notification server, and wherein the process further comprises:
the request from the client system including an indication of the notification channel; and
the notification server sending the push notifications of changes to monitored resources for the client system over the notification channel for the client system.

3. The computer-implemented process of claim 2, wherein the service aggregates information about requests from client systems by the resource being monitored.

4. The computer-implemented process of claim 3, wherein when a resource changes, a push notification is broadcasted to client systems having requested the resource to be monitored.

5. The computer-implemented process of claim 1, wherein monitoring comprises the service periodically polling each resource to be monitored.

6. The computer-implemented process of claim 1, wherein monitoring comprises the service sending a request to the resource with an indication of a destination to which the resource sends a message indicating when the resource has been changed.

7. A service for monitoring of one or more resources, the one or more resources being connected in a computer system including one or more client systems and the service, a resource including a computing device providing information in response to requests from the one or more client systems and the service over one or more computer networks, and a client system including a computing device and an application running on the computing device that requests information from the one or more resources over the one or more computer networks, the client system further being connected to the service over one or more computer networks and having a notification channel, the service comprising:
one or more server computers and
a service application running on the server computer that configures the server computer to:
receive one or more requests into memory from one or more client systems over the one or more computer networks, a request including an indication of one or the resources to be monitored;
monitor, over the one or more computer networks, the one or more resources from the one or more requests for changes;
sending a push notification, after one of the resources changes, to each client system, over the notification channel for the client system, which requested the resource to be monitored about the change.

8. The service of claim 7, wherein the one or more server computers comprises a notification server, and
wherein the request from the client system includes an indication of the notification channel over which the service sends push notifications, and
wherein the notification server sends the push notifications of changes to monitored resources for the client system over the notification channel for the client system.

9. The service of claim 8, wherein the service application further configures the server computer to aggregate information about requests from client systems by the resource being monitored.

10. The service of claim 9, wherein when a resource changes, a push notification is broadcasted to client systems having requested the resource to be monitored.

11. The service of claim 7, wherein the service is configured to periodically poll each resource to be monitored.

12. The service of claim 7, wherein the service is configured to send a request to the resource with an indication of a destination to which the resource sends a message indicating when the resource has been changed.

13. An article of manufacture comprising:
a computer storage medium;
computer program instructions stored on the computer storage medium which, when processed by one or more processing devices, causes the one or more processing devices to be configured as one or more server computers, the one or more server computers configured to:
receive one or more requests into memory from one or more client systems over a computer network, a request including an indication of a resource to be monitored;
monitor, over a computer network, the one or more resources from the one or more requests for changes; and
notify, after a resource changes, each client system that requested the resource to be monitored about the change, by sending a push notification to the client system over a notification channel for the client system.

14. The article of manufacture of claim 13, wherein the one or more server computers comprises a notification server, and
wherein the request from the client system includes an indication of the notification channel over which the service sends push notifications, and
wherein the notification server sends the push notifications of changes to monitored resources for the client system over the notification channel for the client system.

15. The article of manufacture of claim 14, wherein the service application further configures the server computer to aggregate information about requests from client systems by the resource being monitored.

16. The article of manufacture of claim 15, wherein when a resource changes, a push notification is broadcasted to client systems having requested the resource to be monitored.

17. The article of manufacture of claim 13, wherein the service is configured to periodically poll each resource to be monitored.

18. The article of manufacture of claim 13, wherein the service is configured to send a request to the resource with an indication of a destination to which the resource sends a message indicating when the resource has been changed.

19. The article of manufacture of claim 13, wherein the one or more server computers comprises a notification server including a subscription list indicating, for each resource, notification channels for notifying each client system that subscribed to monitor the resource.

20. The article of manufacture of claim 19, wherein the one or more server computers comprises a monitor server including a watch list indicating each resource to be monitored.
